(19) United States
(12) Patent Application Publication
(10) Pub. No.: US 2024/0382373 A1
(43) Pub. Date: Nov. 21, 2024

(54) MASSAGE GUN WITH STEPLESS AMPLITUDE REGULATION

(71) Applicant: Dongguan Fule Technology Co., Ltd., Dongguan (CN)

(72) Inventors: Qiongyao Ao, Shenzhen (CN); Lihao Xia, Shangrao (CN); Xiankui Qiu, Dongguan (CN)

(21) Appl. No.: 18/785,742

(22) Filed: Jul. 26, 2024

(30) Foreign Application Priority Data
Dec. 7, 2023 (CN) 202311671232.5

(51) Int. Cl. A61H 23/00

(52) U.S. Cl. CPC A61H 23/006; A61H 2201/1215; A61H 2201/14; A61H 2201/1454; A61H 2201/5005

(57) ABSTRACT

The present disclosure discloses a massage gun with stepless amplitude regulation. The massage gun with stepless amplitude regulation includes an eccentric wheel assembly. The eccentric wheel assembly includes an input part, a regulating part and an output part. The input part is provided with a first connecting part fixedly connected with a motor rotating shaft. The output part is provided with a second connecting part hinged with a connecting rod. The first connecting part and the second connecting part are arranged non-coaxially. The regulating part is movably connected with the input part and the output part. An amplitude regulation assembly and a massage head operating assembly are independently controlled respectively, and can synergistically operate mutually without interference, and the noise during amplitude regulation and massage can be reduced. Accumulated tolerance after every time of amplitude regulation can be corrected by a correction circuit arranged inside.

### TECHNICAL FIELD

The present disclosure relates to the field of massage gun correlation technique, in particular to a massage gun with stepless amplitude regulation.

### BACKGROUND

The existing massage drive mechanism is a fixed eccentric shaft, and the eccentric distance cannot be regulated. For example, the motor of the massage drive mechanism with a hitting distance of 8 mm has the same hitting distance in the cases of forward rotation and reverse rotation, so the customer can feel pain when the position with less muscles is hit in the case of large hitting distance, and the massage effect is not obvious when the position with more muscles is hit in the case of small hitting distance, so the requirements of the customer for different amplitudes of the massage gun when different positions are massaged cannot be met.

In order to solve the above problems, people have designed a driving mechanism and a massage gun that drive an eccentric wheel to form two different eccentric distances through forward rotation and reverse rotation of a motor. For example, in the patent CN201921394700.8, a massage driving mechanism with variable amplitude and a massage gun are provided. In the present disclosure, a guide column can move around a lower erection column in a rotating fixed arc groove. When the guide column moves to one end of the rotating fixed arc groove, the eccentric distance between the eccentric shaft and an eccentric wheel body is e1. When the guide column moves to the other end of the rotating fixed arc groove, the eccentric distance between the eccentric shaft and a rotational center of the eccentric wheel body is e2, and e2 is not equal to e1.

The above is the first disadvantage of the conventional technology, and there are only two gears of amplitude. For the second disadvantage, when the two gears of amplitude are switched, the rotational direction of the motor needs to change, which is unfavorable to the motor. At the same time, the guide column needs to rotate from one end of the fixed arc groove to the other end of the fixed arc groove. Time is needed. Therefore, there is an instantaneous stop, which is not conducive to the consumer experience. In the above-mentioned patent, the same power source is used for driving the eccentric wheel to rotate and the horizontal position of the output end of the eccentric wheel, so the gears are switched only by the forward rotation and reverse rotation of the motor, so there are only two gears with amplitude regulation. A regulatable stepless amplitude range is not achieved, and the applicability is not high.

### SUMMARY

The present disclosure aims to provide a massage gun with stepless amplitude regulation so as to overcome the disadvantages in the prior art.

In order to achieve the above-mentioned purpose, the present disclosure provides the following technical scheme.

A massage gun with stepless amplitude regulation includes an eccentric wheel assembly. The eccentric wheel assembly includes an input part, a regulating part and an output part, the input part is provided with a first connecting part fixedly connected with a motor rotating shaft, and the output part is provided with a second connecting part hinged with a connecting rod. The first connecting part and the second connecting part are arranged non-coaxially, the regulating part is movably connected with the input part and the output part, and the input part is slidably connected with the output part so as to regulate the distance between a central axis of the first connecting part and a central axis of the second connecting part.

Further, the massage gun with stepless amplitude regulation includes a control mechanism. The control mechanism includes a power component, a transmission assembly and a regulating sleeve. The power component is in transmission connection with the regulating sleeve through the transmission assembly so as to control the translation of the regulating part.

Further, the power component is a second motor. The transmission assembly includes a gear box, a thread sleeve and a screw, the regulating sleeve is fixedly connected with the thread sleeve, the thread sleeve is in threaded connection with the screw, and the second motor is in transmission connection with the screw through the gear box. An inner wall of the regulating sleeve is provided with a first bearing in a close-fitting manner, and an inner ring of the first bearing is in close-fitting connection with the regulating part.

Further, the power component is a second motor. The transmission assembly is a straight gear. The straight gear is in interference fit with a rotating shaft of the second motor. A large gear sleeves the outer side of the regulating sleeve. An outer side wall of the large gear is meshed with the straight gear. The large gear extends downwards to be provided with an internal thread sleeve. The internal thread sleeve is in threaded connection with the regulating sleeve. The straight gear is meshed and in transmission connection with the regulating sleeve. The regulating sleeve extends downwards to be provided with an external thread sleeve. The external thread sleeve is in threaded connection with the internal thread sleeve. The external thread sleeve sleeves the regulating part through a third bearing. The regulating part 9 is rotatably connected with the external thread sleeve through the third bearing. An inner ring of the third bearing is in close fit with the regulating part, and an outer ring of the third bearing is in close fit with the external thread sleeve.

Further, the massage gun with stepless amplitude regulation also includes a motor support. The motor support is fixedly arranged inside a shell of the massage gun. The motor support is fixedly provided with a sliding rod. The sliding rod runs through the regulating sleeve. The regulating sleeve is slidably connected with the sliding rod.

Further, the regulating part moves in the vertical direction so as to control the output part to get away from an input end or get close to the input end in the horizontal direction.

Further, the regulating part sleeves the first connecting part. The regulating part also extends downwards integrally to be provided with an ejector rod. The ejector rod is inserted in the output part. Inclined slots are formed in both sides of an inner wall of the output part respectively. Both side walls, close to the bottom, of the ejector rod on an inclined plane are provided with inclined blocks corresponding to the inclined slots. The inclined block is slidably buckled with the inclined slot.

Further, the output part is slidably arranged inside the input part. Both ends of the output part are provided with a sleeve rod and a sliding block respectively. A movable cavity is formed in the interior of the input part. The movable cavity is internally and fixedly provided with a spring. The other end of the spring sleeves the sleeve rod. A copying concave hole is also formed in the input part. The output part is slidably connected with the copying concave hole through the sliding block.

Further, the massage gun with stepless amplitude regulation also includes a main motor. The input part sleeves a rotating shaft of the main motor, and the rotating shaft of the main motor is in close-fitting connection with an inner wall of the first connecting part.

Further, the second connecting part is connected with bolts through threads. The second connecting part is clamped with a second bearing through the bolts. The second connecting part is rotatably connected with a connecting rod through the second bearing. The other end of the connecting rod is hinged with a massage piston.

Compared with the prior art, the present disclosure has the following beneficial effects:

According to the massage gun, stepless amplitude regulation can be realized, the amplitude can be regulated by a customer without a pause feeling when the massage gun is used. An amplitude regulation assembly and a massage head operating assembly are independently controlled respectively, and can synergistically operate mutually without interference, and the noise during amplitude regulation and massage can be reduced. Accumulated tolerance after every time of amplitude regulation can be corrected by a correction circuit arranged inside.

### BRIEF DESCRIPTION OF THE DRAWINGS

FIG. 1 is a solid structural schematic diagram of the present disclosure.

FIG. 2 is a section view of an internal main structure in the present disclosure.

FIG. 3 is a disassembly diagram of an eccentric wheel assembly.

FIG. 4 is a section view of a second embodiment.

FIG. 5 is a structural schematic diagram of an ejector rod at the highest extreme position in a first embodiment of the present disclosure.

Reference signs in attached figures:

1, main motor; 2, motor support; 3, sliding rod; 4, second motor; 5, first bearing; 6, screw; 7, thread sleeve; 8, regulating sleeve; 9, regulating part; 10, input part; 11, output part; 12, spring; 13, sleeve rod; 14, sliding block; 15, copying concave hole; 16, connecting rod; 17, massage piston; 18, second bearing; 19, first connecting part; 20, second connecting part; 21, inclined slot; 22, inclined block; 23, ejector rod; 24, movable cavity; 25, third bearing; 26, fourth bearing; 27, external thread sleeve; 28, large gear; 29, internal thread sleeve; and 30, straight gear.

### DETAILED DESCRIPTION OF THE EMBODIMENTS

To make the foregoing objective, features and advantages of the present disclosure clearer and more comprehensible, the specific embodiment of the present disclosure is further described in detail below with reference to the attached figures. Many specific details are elaborated in the following description, so that the present disclosure is sufficiently understood. However, the present disclosure can be implemented in many other ways different from those described herein, and those skilled in the art can make similar improvements without violating the meaning of the present disclosure, so that the present disclosure is not subject to specific implementations disclosed below.

What needs illustration is that when one component is referred to as being “fixed” on the other component, the component can be directly arranged on the other element or an intermediate component can exist. When one component is referred to as being “connected” to the other component, the component can be directly connected to the other component or an intermediate component exists possibly at the same time. When the components are referred to as “a plurality of” components, the components can be two or more components. As used herein, the terms “vertical,” “horizontal,” “left,” “right,” and similar expressions are used for illustrative purposes only and but not intended to be the only embodiment.

Unless otherwise defined, all technical and scientific terms used herein shall have the same meanings as commonly understood by those skilled in the art to which the present disclosure belongs. The terms used in the specification of the present disclosure are merely intended to describe specific embodiments but not intended to constitute any limitation on the present disclosure. As used herein, the term “and/or” includes any and all combinations of one or more associated listed items.

The present disclosure is described in detail in conjunction with the following embodiments as shown in the attached figures.

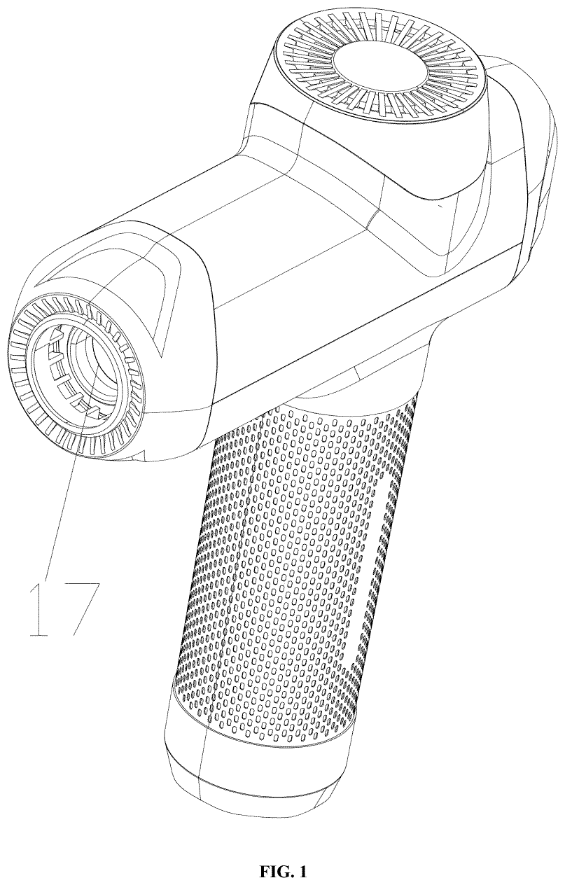

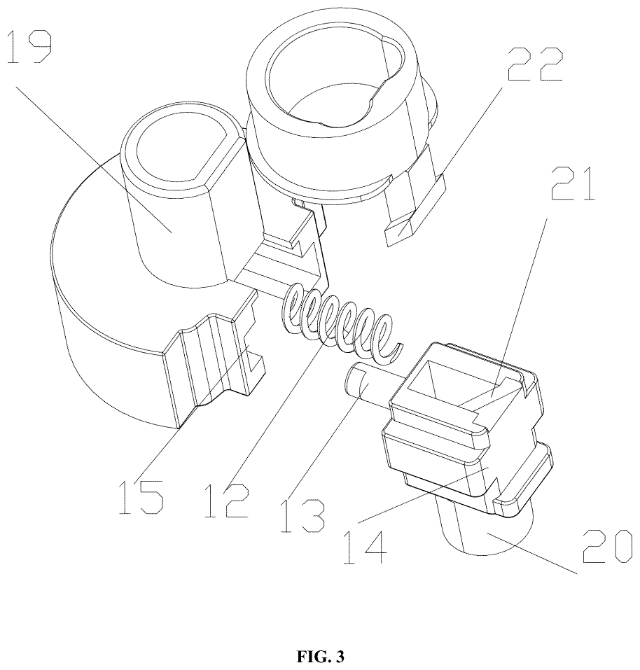

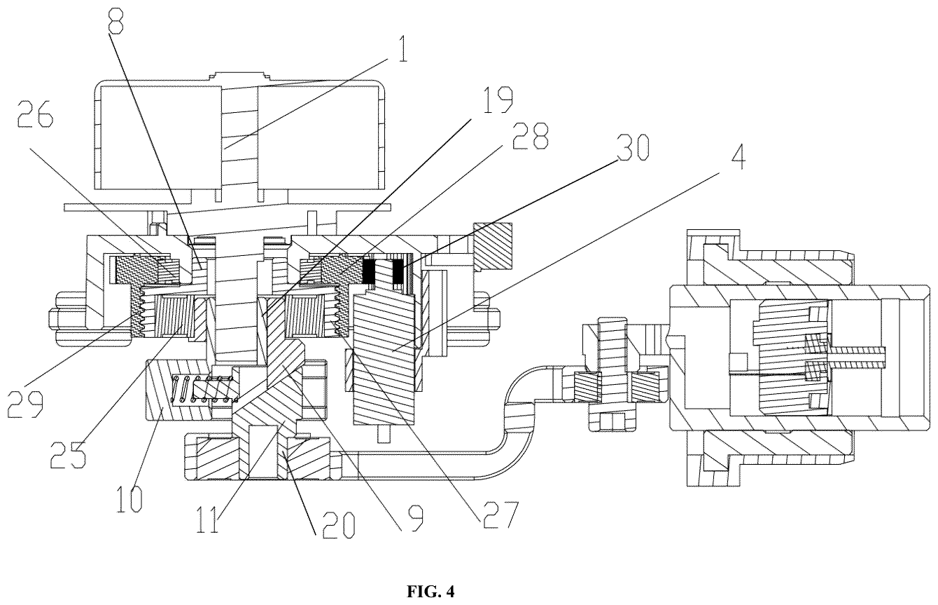

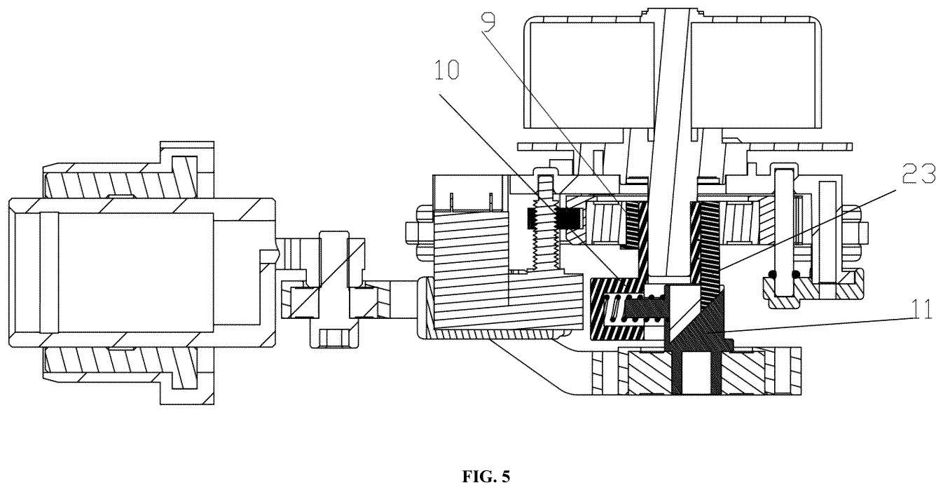

As shown in FIG. 1 to FIG. 5, a massage gun with stepless amplitude regulation is provided in the embodiment. The massage gun with stepless amplitude regulation includes an eccentric wheel assembly. The eccentric wheel assembly is a core of the product, and the functions of rotation and stepless amplitude regulation can be realized, wherein the eccentric wheel assembly includes an input part 10, a regulating part 9 and an output part 11, the input part 10 is provided with a first connecting part 19 fixedly connected with a motor rotating shaft, and the output part 11 is provided with a second connecting part 20 hinged with a connecting rod 16. The first connecting part 19 and the second connecting part 20 are arranged non-coaxially, and the amplitude of a massage head of the massage gun can be influenced by the distance between the two connecting parts. Therefore, the present disclosure focuses on the regulation of the distance between the two parts. The regulating part 9 is movably connected with the input part 10 and the output part 11, and the input part 10 is slidably connected with the output part 11 so as to regulate the distance between a central axis of the first connecting part 19 and a central axis of the second connecting part 20. Specifically, the vertical distance between the central axes of the two connecting parts is the radial distance. Further, the massage gun with stepless amplitude regulation also includes a main motor 1. The input part 10 sleeves a rotating shaft of the main motor 1, and the rotating shaft of the main motor 1 is in close-fitting connection with an inner wall of the first connecting part 19. Threaded holes are formed in the interior of the second connecting part 20, and the second connecting part 20 is in threaded connection with bolts through the threaded holes. In order to ensure that the position of a second bearing 18 does not move, the second connecting part 20 is clamped with the second bearing 18 through the bolts, the second connecting part 20 is rotatably connected with a connecting rod 16 through the second bearing 18, and the other end of the connecting rod 16 is hinged with a massage piston 17. A bearing fixed to the piston is arranged outside the piston 17, and the bearing moves straightly back and forth at the same time.

In the embodiment, in order to enable the amplitude in the massage gun to be regulatable electrically, a control mechanism is arranged inside the massage gun. The control mechanism includes a power component, a transmission assembly and a regulating sleeve 8. The power component is in transmission connection with the regulating sleeve 8 through the transmission assembly, and the positions of the regulating sleeve 8 and the regulating part 9 are relatively fixed. The regulating part 9 also can move up and down simultaneously along with the regulating sleeve 8 while the transmission assembly can control the up-and-down movement of the regulating sleeve 8.

In the embodiment, the massage gun also includes a motor support 2. The motor support 2 is used for installing a main motor 1. The main motor 1 is used for controlling the eccentric wheel assembly to rotate. The motor support 2 is fixedly arranged in a shell of the massage gun. The motor support 2 is fixedly provided with a sliding rod 3. The sliding rod 3 runs through the regulating sleeve 8. The regulating sleeve 8 is slidably connected with the sliding rod 3. The control mechanism is connected to the regulating sleeve 8 on only one side, and the massage head can move to a certain extent when the massage head operates. Therefore, the joint between the control mechanism and the regulating sleeve 8 can bear a certain shear stress. Because a second motor 4 moves the regulating sleeve 8 up and down through the transmission assembly, the force is unilateral to easily generate torque. In order to reduce stress concentration, the sliding rod 3 is arranged on the other side away from the control mechanism to help the control mechanism support the regulating sleeve 8. The regulating sleeve 8 slides on the sliding rod 3, and the stress of the regulating sleeve 8 moving up and down is more balanced.

In the embodiment, the regulating part 9 moves in the vertical direction so as to control the output part 11 to get away from an input end or get close to the input end in the horizontal direction.

Specifically, the regulating part 9 sleeves the first connecting part 19, and the regulating part 9 is not in close fit with the first connecting part 19, that is, the regulating part 9 can move up and down relative to the input part 10, the up-and-down movement of the regulating part 9 cannot affect the normal rotation of the input part 10, and the rotation of the input part 10 also cannot affect the up-and-down sliding of the regulating part 9, so that the amplitude regulation can be realized in the process of massage. The regulating part 9 also extends downwards integrally to be provided with an ejector rod 23. The ejector rod 23 is inserted in the output part 11. Inclined slots 21 are formed in both sides of an inner wall of the output part 11 respectively. Both side walls, close to the bottom, of the ejector rod 23 on an inclined plane are provided with inclined blocks 22 corresponding to the inclined slots 21. The inclined block 22 is slidably buckled with the inclined slot 21. The inclined block 22 can move along with the trajectory of the inclined slot 21, and both side walls of the inclined block 22 can abut against the side of the inclined slot 21, so that the output part 11 can be positioned. That is, as long as the position of the regulating part 9 remains constant, the relative position of the output part 11 can be limited, and the regulating part 9 can also restrict the position of the output part 11 from being constant during the rotation process by virtue of the abutting between the inclined block 22 and the inclined slot 21.

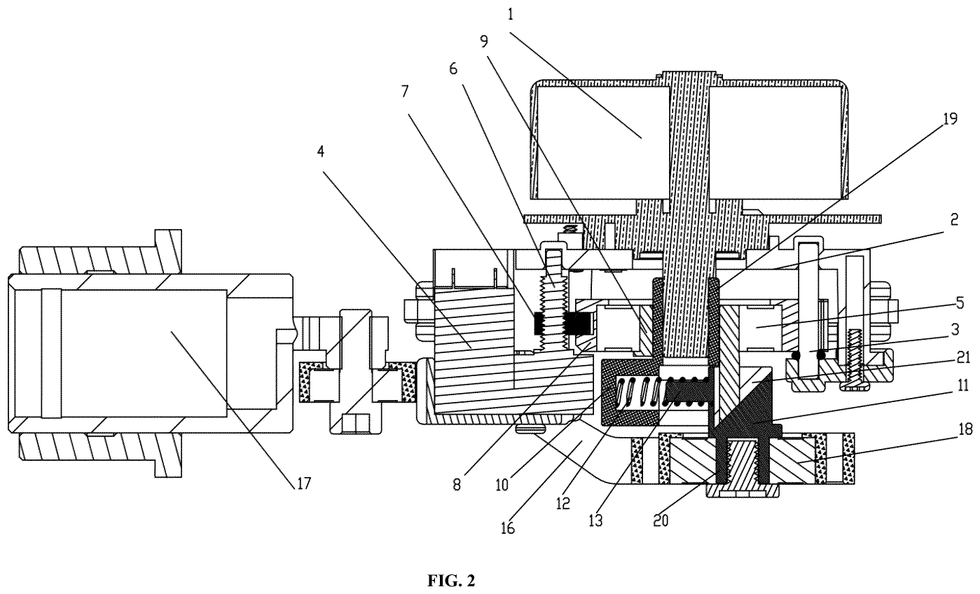

Refer to FIG. 2, in the rotation process, the input part 10 actively rotates to control the regulating part 9 and the output part 11 to rotate. Because a first bearing 5 is arranged between the regulating part 9 and the regulating sleeve 8, and the regulating part 9 is in close fit with an inner ring of the first bearing 5, so the regulating sleeve 8 cannot rotate even if the regulating part 9 rotates. When it is necessary to regulate the amplitude, that is, when the pitch between the input part 10 and the output part 11 is to be regulated, the position of the regulating part 9 needs to be translated up and down to control the change of the distance between the first connecting part 19 and the second connecting part 20.

In the embodiment, the output part 11 is slidably arranged inside the input part 10. In order to ensure the smooth sliding of the output part 11, both ends of the output part 11 are provided with a sleeve rod 13 and a sliding block 14 respectively. A movable cavity 24 is formed in the interior of the input part 10. The movable cavity 24 is internally and fixedly provided with a spring 12. The other end of the spring 12 sleeves the sleeve rod 13. The spring 12 can play a role of cushioning. At the same time, jumpy alternating load caused by the control mechanism during high-speed movement of the connecting rod 16 can be reduced to a certain extent. A copying concave hole 15 is also formed in the input part 10, and the output part 11 is slidably connected with the copying concave hole 15 through the sliding block 14. The sliding block 14 is generally arranged as a rectangular block, but in the embodiment, the sliding block 14 is preferably made as a cross-shaped block, and the shape of the copying hole corresponds to the shape of the sliding block 14. Damping oil is filled between the copying concave hole 15 and the sliding block 14. Since the damping oil is relatively thick compared with ordinary oil, the vibration between the output end and the input end is obviously reduced, and the noise is reduced. Damping oil is also filled between a screw 6 and a thread sleeve 7, so that vibration between the screw 6 and the thread sleeve 7 is reduced, and the noise is reduced.

In summary, for the driving mode of the control mechanism, the following two alternative embodiments are included.

In the first embodiment, optionally, the power component is the second motor 4. The transmission assembly includes a gear box, a thread sleeve 7 and a screw 6, and the regulating sleeve 8 is fixedly connected with the thread sleeve 7. As shown in FIG. 2, one end of the thread sleeve 7 is embedded and fixed on one side of the regulating sleeve 8. The thread sleeve 7 is in threaded connection with the screw 6, and the second motor 4 is in transmission connection with the screw 6 through the gear box, that is to say, the screw 6 is controlled to rotate when the second motor 4 is started, the thread sleeve 7 can be controlled to move in the vertical direction when the screw 6 rotates, and the vertical direction here refers to controlling the thread sleeve 7 to move in the axial direction relative to a shaft axis of the motor rotating shaft. It is worth mentioning that an inner wall of the regulating sleeve 8 is provided with the first bearing 5 in a close-fitting manner, and an inner ring of the first bearing 5 is connected with the regulating part 9 in a close-fitting manner, that is to say, when the regulating sleeve 8 moves up and down, the regulating part 9 can move in the vertical direction. At the same time, the first bearing 5 for transition is arranged between the regulating part 9 and the regulating sleeve 8, that is to say, the rotation of the regulating part 9 cannot be affected during the lifting and translation process of the regulating sleeve 8.

Further, the inner wall of the first bearing 5 is in close fit with an outer wall of the regulating part 9. An outer wall of the first bearing 5 is in close fit with the inner wall of the regulating sleeve 8, so the regulating sleeve 8 can easily realize the rotation of the motor shaft, the amplitude can be regulated, and the consumer experience can be improved.

When the screw 6 rotates forward, the regulating sleeve 8 with the thread sleeve 7 moves upward. When the screw 6 rotates reversely, the regulating sleeve 8 with the thread sleeve 7 moves downward. The screw pitch of the screw 6 is constant, and the rotational speed of the screw 6 fluctuates in a relatively small range. The screw 6 is preferably M4, and the screw pitch is 0.7 mm. The screw 6 rotates by a turn, and the regulating sleeve 8 moves by 0.7 mm. Therefore, by controlling the time (controlling the rotation time of the motor to control the screw 6 to rotate by a turn every click), the multi-stage control of the up-and-down movement distance of the regulating sleeve 8 can be realized, and stepless amplitude regulation of the massage gun can be realized, so that the requirement of each massage intensity is met.

Further, in the assembly mode of the embodiment, a hole is formed in the motor support 2. A front end of the screw 6 is arranged in the shape of a column. The diameter of the column is smaller than that of the thread sleeve 7. The thread sleeve 7 of the regulating sleeve 8 is separated (for convenience of assembly). The thread sleeve 7 perpendicularly provided with a column at the thread center line. A hole is formed in the regulating sleeve 8. First, the motor, the motor support 2, the eccentric wheel assembly, the first bearing 5 and the thread sleeve 7 are assembled into an assembly in advance, and then the thread sleeve 7 is screwed on the screw 6 in advance. And then, the regulating sleeve 8 is manually pulled down. Then, the thread sleeve 7 and the regulating sleeve 8 are fixedly connected and inserted upwards. The screw 6 is inserted into the hole in the motor support 2, and finally a motor cover presses the motor and locks the screw on a screw column on the motor support 2, so that the second motor 4 is fixedly connected with the motor support 2. Thus, the screw 6 is strengthened, the feasibility of the entire mechanism is increased, and assembling is facilitated.

In the second embodiment, optionally, the power component is the second motor 4. The transmission assembly is a straight gear 30. The straight gear 30 is in interference fit with a rotating shaft of the second motor 4. A large gear 28 sleeves the outer side of the regulating sleeve 8. An outer side wall, close to the top, of the large gear 28 is meshed with the straight gear 30. The large gear 28 extends downwards to be provided with an internal thread sleeve 29. The internal thread sleeve 29 is in threaded connection with the regulating sleeve 8. The regulating sleeve 8 can move up and down freely relative to the motor support. The straight gear 30 is meshed with the large gear 28. The large gear 28 includes the internal thread sleeve 29 extending downwards. Therefore, the internal thread sleeve 29 and the large gear 28 rotate synchronously. The rotation of the internal thread sleeve 29 can control the regulating sleeve in threaded connection with the internal thread sleeve 29 to move up and down. The structure of the regulating sleeve is further elaborated. The regulating sleeve 8 extends downwards to be provided with the external thread sleeve 27. The external thread sleeve 27 is in threaded connection with the internal thread sleeve 29. The external thread sleeve 27 sleeves the regulating part 9 through the third bearing 25. The regulating part 9 is rotatably connected with the external thread sleeve 27 through the third bearing 25. It is worth mentioning that an inner ring of the third bearing 25 is in interference fit with the regulating part 9, and an outer ring of the third bearing 25 is in close fit with the external thread sleeve 27, so when the external thread sleeve 27 moves up and down, the regulating part 9 can move up and down synchronously along with the external thread sleeve 27.

In the embodiment, the inner side, close to the top, of the large gear 28 is also provided with a fourth bearing 26, and an inner ring of the fourth bearing 26 is fixed to the motor support 2, so the large gear 28 can freely rotate relative to the motor support 2 through the fourth bearing 26.

Specifically, the regulating part 9 sleeves the input part 10, and the first connecting part 19 of the input part 10 is not in close-fitting connection with the regulating part 9, so the regulating part 9 can freely move up and down relative to the input part 10. When rotating, the regulating part 9 and the input part 10 rotate together, and rotate about a rotating shaft of the main motor 1. Because of the presence of the third bearing 25, the up-and-down movement of the regulating part 9 during rotation cannot cause the external thread sleeve 27 to rotate together. That is to say, the up-and-down rotating movement of the external thread sleeve 27 is not affected by the rotation of the regulating part 9, so stepless amplitude regulation during the vibration of the massage gun can be realized. The up-down movement of the external thread sleeve 27 controls the up-down movement of the regulating part 9, and then the distance between the output part 11 and the input part 10, namely the distance between the first connecting part 19 and the second connecting part, is controlled. The rest is the same as that in the above embodiment.

In order to increase the consumer experience, a display screen can be arranged to clearly display the current amplitude. A touch switch is arranged on the display screen, and a “−” switch and a “+” switch are respectively used for controlling the forward rotation and the reverse rotation of the second motor 4.

By controlling the time, the number of turns of the screw 6 is controlled to achieve the amplitude desired by the consumer. A tiny gap is formed between the screw 6 and the thread sleeve 7, and the delay is also small at the moment of starting the second motor 4. With more times of regulation, there will be obvious accumulated tolerance. The initialization can be set in the software in the circuit. The amplitude range of the massage gun is (a, b), a is the minimum amplitude, and b is the maximum amplitude. After the regulation reaches N (N is preferably between 30 and 50) times, if the corresponding amplitude is theoretically a+2, but an error may have occurred, the actual amplitude is a+2.6. After the N optionally in the embodiment is 40, if the “−” switch is triggered once at this time, the second motor 4 will no longer only rotate forward by 0.714 turns, but the second motor 4 will rotate forward until the upward moving regulating sleeve 8 abuts against a lower wall of the motor support 2, and the motor current is obviously excessive. At this time, the amplitude is initialized to be a, and then the second motor 4 immediately rotates reversely by 0.714 turns, so that the amplitude reaches a+1. Finally, the deviation generated after the amplitude is regulated for many times can be corrected.

Similarly, after the regulation reaches N (N is preferably between 30 and 50) times, if the corresponding amplitude is theoretically b−3, but an error may have occurred, the actual amplitude is b−2.2. After the N optionally in the embodiment is 40, if the “+” switch is triggered once at this time, the second motor 4 will no longer only rotate reversely by 0.714 turns, but the second motor 4 will rotate reversely until the downward moving regulating sleeve 8 abuts against a stop position of the second motor 4, and the motor current is also obviously excessive. At this time, the amplitude is initialized to be b, and then the second motor 4 immediately rotates forward by 0.714 turns, so that the amplitude reaches b−2. Finally, the deviation generated after the amplitude is regulated for many times can be corrected.

The technical features of the above-mentioned embodiments may be arbitrarily combined, and all possible combinations of the technical features in the above-mentioned embodiments are not described for simplicity of description. However, as long as the combinations of the technical features do not contradict one another, the technical features should be considered to be within the scope of the description of the present disclosure. Those skilled in the art may make several deformation and improvements without departing from the principle of the present disclosure, and the deformation and improvements shall fall within the protection scope of the present disclosure. Therefore, the protection scope of the present disclosure shall be subject to the protection scope of the claims.

What is claimed is:

1. A massage gun with stepless amplitude regulation, comprising an eccentric wheel assembly, wherein the eccentric wheel assembly comprises an input part, a regulating part and an output part, the input part is provided with a first connecting part fixedly connected with a motor rotating shaft, and the output part is provided with a second connecting part hinged with a connecting rod; the first connecting part and the second connecting part are arranged non-coaxially, the regulating part is movably connected with the input part and the output part, and the input part is slidably connected with the output part so as to regulate the distance between a central axis of the first connecting part and a central axis of the second connecting part.

2. The massage gun with stepless amplitude regulation according to claim 1, comprising a control mechanism, wherein the control mechanism comprises a power component, a transmission assembly and a regulating sleeve, the power component is in transmission connection with the regulating sleeve through the transmission assembly so as to control the translation of the regulating part.

3. The massage gun with stepless amplitude regulation according to claim 2, wherein the power component is a second motor, the transmission assembly comprises a gear box, a thread sleeve and a screw, the regulating sleeve is fixedly connected with the thread sleeve, the thread sleeve is in threaded connection with the screw, and the second motor is in transmission connection with the screw through the gear box; an inner wall of the regulating sleeve is provided with a first bearing in a close-fitting manner, and an inner ring of the first bearing is in close-fitting connection with the regulating part.

4. The massage gun with stepless amplitude regulation according to claim 2, wherein the power component is a second motor, the transmission assembly is a straight gear, the straight gear is in interference fit with a rotating shaft of the second motor, a large gear sleeves the outer side of the regulating sleeve, an outer side wall of the large gear is meshed with the straight gear, the large gear extends downwards to be provided with an internal thread sleeve, the internal thread sleeve is in threaded connection with the regulating sleeve, the straight gear is meshed and in transmission connection with the regulating sleeve, the regulating sleeve extends downwards to be provided with an external thread sleeve, the external thread sleeve is in threaded connection with the internal thread sleeve, the external thread sleeve sleeves the regulating part through a third bearing, the regulating part 9 is rotatably connected with the external thread sleeve through the third bearing, an inner ring of the third bearing is in close fit with the regulating part, and an outer ring of the third bearing is in close fit with the external thread sleeve.

5. The massage gun with stepless amplitude regulation according to claim 3, also comprising a motor support, wherein the motor support is fixedly arranged inside a shell of the massage gun, the motor support is fixedly provided with a sliding rod, the sliding rod runs through the regulating sleeve, and the regulating sleeve is slidably connected with the sliding rod.

6. The massage gun with stepless amplitude regulation according to claim 4, also comprising a motor support, wherein the motor support is fixedly arranged inside a shell of the massage gun, the motor support is fixedly provided with a sliding rod, the sliding rod runs through the regulating sleeve, and the regulating sleeve is slidably connected with the sliding rod.

7. The massage gun with stepless amplitude regulation according to claim 1, wherein the regulating part moves in the vertical direction so as to control the output part to get away from an input end or get close to the input end in the horizontal direction.

8. The massage gun with stepless amplitude regulation according to claim 1, wherein the regulating part sleeves the first connecting part, the regulating part also extends downwards integrally to be provided with an ejector rod, the ejector rod is inserted in the output part, inclined slots are formed in both sides of an inner wall of the output part respectively, both side walls, close to the bottom, of the ejector rod on an inclined plane are provided with inclined blocks corresponding to the inclined slots, and the inclined block is slidably buckled with the inclined slot.

9. The massage gun with stepless amplitude regulation according to claim 7, wherein the regulating part sleeves the first connecting part, the regulating part also extends downwards integrally to be provided with an ejector rod, the ejector rod is inserted in the output part, inclined slots are formed in both sides of an inner wall of the output part respectively, both side walls, close to the bottom, of the ejector rod on an inclined plane are provided with inclined blocks corresponding to the inclined slots, and the inclined block is slidably buckled with the inclined slot.

10. The massage gun with stepless amplitude regulation according to claim 1, wherein the output part is slidably arranged inside the input part, both ends of the output part are provided with a sleeve rod and a sliding block respectively, a movable cavity is formed in the interior of the input part, the movable cavity is internally and fixedly provided with a spring, the other end of the spring sleeves the sleeve rod, a copying concave hole is also formed in the input part, and the output part is slidably connected with the copying concave hole through the sliding block.

11. The massage gun with stepless amplitude regulation according to claim 1, also comprising a main motor, wherein the input part sleeves a rotating shaft of the main motor, and the rotating shaft of the main motor is in close-fitting connection with an inner wall of the first connecting part.

12. The massage gun with stepless amplitude regulation according to claim 1, wherein the second connecting part is connected with bolts through threads, the second connecting part is clamped with a second bearing through the bolts, the second connecting part is rotatably connected with a connecting rod through the second bearing, and the other end of the connecting rod is hinged with a massage piston.
